(19) United States
(12) Patent Application Publication
(10) Pub. No.: US 2016/0299980 A1
(43) Pub. Date: Oct. 13, 2016

(54) A SYSTEM AND METHOD FOR DELIVERING CURATED AND RELEVANT ASSETS TO END USERS

(71) Applicant: Naval SAINI, New Delhi (IN)

(72) Inventor: Naval SAINI, New Delhi (IN)

(21) Appl. No.: 15/101,093

(22) PCT Filed: Jun. 27, 2014
(86) PCT No.: PCT/IN2014/000432

§ 371 Date: Jun. 2, 2016

(30) Foreign Application Priority Data
Dec. 3, 2013 (IN) 3515/DEL/2013

(51) Int. Cl. G06F 17/30; G06Q 50/00

(52) U.S. Cl. CPC G06F 17/30867; G06F 17/3053; G06Q 50/01

(57) ABSTRACT

The present invention discloses a computer implemented method for providing quality content to a user, the content being one or more of audio, pictures, text, or video content and the like. The computer implemented method includes creating a list of topics. Further the method includes, identifying subject experts corresponding to each of the topics and aggregating content shared by the subject experts from their personalized accounts. Furthermore the method includes receiving one or more query terms from a user (the user inputting the one or more query in a data processing device), and searching for query terms by looking the query terms in the aggregated content to identify the most relevant content corresponding to the query terms. Finally the computer implemented method displays the content to the user, wherein the displaying is done on the data processing device.

### FIELD OF THE DISCLOSURE

This invention relates to a computer implemented method for providing quality content to a user, and more particularly, to provide content shared by subject experts on their personalized accounts.

### BACKGROUND OF THE DISCLOSURE

In today's technologically running world, internet has become a medium for the user to look-up for any kind of contents or assets. The contents or assets could be one or more of audio, pictures, text, or video content and the like, which may be of interest to the end user. After searching for the contents or assets on the internet, the users retrieve or simply go through the presented results and in this way keep themselves updated on the topic of interest or to discover new knowledge.

However, when a user looks for any asset or content on the internet, he/she is interested in looking for relevant assets or contents and that too in very short time. In other words, a user would like to identify for relevant assets and content whenever he/she is looking for it. Though it is believed that internet is one of the best medium for asset or content retrieval, the internet searches do not assure of presenting most relevant contents or assets to the user. Moreover, the searches may take a lot of time to present relevant contents or assets to the user. Such prolong time for searching is undesirable.

Since the advent of search engines such as Google, Yahoo search, the above mentioned problems of retrieving relevant content or asset has been reduced up to some extent. Searching mediums, such as Google and Yahoo search, usually reveals a lot of information, rather than user desired information. Accordingly, a user is usually unable to judge the quality of content provided by such search engine. Google usually retrieves too much content for any ones use.

On the other hand, the amount of content being generated online daily is on a verge of increase. It's simply too much content for people to consume. And as fresh content keeps adding over the older content, there is a higher chance that a good piece of content would get lost and never get discovered. Accordingly, the present day solutions are not enough to provide the most relevant contents or assets in short time.

Accordingly, there is a need for developing a method which can deliver limited as well as relevant contents or assets in minimum possible time. Further there is need of such a method where user would be able to search for contents or assets, depending on his/her need. For example, if the user is looking for beginner content, the user is able to find beginner content, and in case the user intends to look for advance content, he/she is able to find advanced content.

Furthermore, there is a growing need to ensure that the contents or assets should come from reliable sources and accordingly these contents or assets are needed to be rated or scored based on their creator. Moreover, there is a further need of discussion forum or like, where users are able to clear doubts on the contents or assets, if required. There is also a need of developing a method which incorporates a feedback mechanism from the users in order to facilitate user participation in process of selecting the best assets or contents. In this manner user may get most relevant content or asset on one search and may rely on the presented content or asset.

### OBJECTS OF THE DISCLOSURE

In view of the foregoing disadvantages inherent in the prior art, the general purpose of the present invention is to conveniently provide a computer implemented method for providing quality content to a user. The computer implemented method solves the above mentioned problems algorithmically and using information available on internet.

Accordingly, one object of the present invention is to develop a method which can deliver limited as well as relevant contents to a user thus saving their time & effort, for example in form of personalized news or daily updates on topics of interest.

Another object of the present invention is to develop such a method where user would be able to search for contents or assets, depending on his/her need.

Yet another object of the present invention to ensure that the contents or assets are coming from reliable sources and accordingly these contents or assets will be to be rated or scored based on their creator.

Yet another object of the present invention is to develop discussion forums or like, where users will be able to clear doubts on the contents or assets, if required.

Yet another object of the present invention is to develop a method which incorporates a feedback mechanism from the users in order to facilitate user participation in process of selecting the best assets or content.

These and other objects and advantages of the invention will be clear from the ensuing description.

### SUMMARY OF THE DISCLOSURE

In view of the foregoing disadvantages inherent in the prior-art and the needs as mentioned above, the general purpose of the present disclosure is to provide a computer implemented method for providing quality content to a user. The computer implemented method is configured to include all advantages of the prior art and to overcome the drawbacks inherent in the prior art offering some added advantages.

The present invention provides solution to this problem by presenting a computer implemented method for providing quality content to a user. The content is one or more of audio, pictures, text, or video content and the like. The computer implemented method includes creating a list of topics. Further the computer implemented method includes, identifying subject experts corresponding to each of the topics and aggregating content shared by the subject experts from their personalized accounts, such as twitter accounts or other social media accounts. In one of embodiment, the subject experts are identified based on social media footprint corresponding to a pool of subject experts. In other embodiment, the subject experts are derived from a list of predetermined experts stored in an expert database. Moreover, the personalized accounts includes one or more of social network accounts, twitter accounts, Facebook accounts, discussion forums and personalized blogs. In another embodiment, the personalized accounts are dedicated third party website accounts.

Furthermore when the computer implemented method receives one or more query terms from a user. The user inputs the one or more query in a data processing device. Further the computer implemented method includes searching for query terms by looking the query terms in the aggregated content to identify the most relevant content corresponding to the query terms. Finally the computer implemented method displays the content to the user. The displaying is done on the data processing device. In one embodiment, the identified content is ranked based on a profile of the user to provide more relevant content to the user. In this manner, most relevant and quality content is provided to the user.

This together with the other aspects of the present invention along with the various features of novelty that characterized the present disclosure is pointed out with particularity in claims annexed hereto and forms a part of the present invention. For better understanding of the present disclosure, its operating advantages, and the specified objective attained by its uses, reference should be made to the accompanying descriptive in which there are illustrated exemplary embodiments of the present invention.

### BRIEF DESCRIPTION OF THE DRAWINGS

The advantages and features of the present invention will become better understood with reference to the following detailed description taken in conjunction with the accompanying drawings, in which:

FIG. 1 illustrates a flow diagram of a computer implemented method for providing quality contents or assets to a user, in accordance with various embodiments of the present invention;

FIG. 2 illustrates a block diagram of a computer implemented method for creating a subject expert list on a particular topic, in accordance with various embodiments of the present invention;

FIG. 3 illustrates a block diagram of a computer implemented method for fetching relevant content or asset uploaded on internet, in accordance with various embodiments of the present invention;

FIG. 4 illustrates a block diagram of a computer implemented method for analysing contents and assets and for filtering contents or assets, in accordance with various embodiments of the present invention;

FIG. 5 illustrates a schematic representation of a computer implemented method for content or assets delivery in a personalised manner, in accordance with various embodiments of the present invention;

FIGS. 6-7 and 13 illustrate schematic representations of a system for providing quality content to a user, in accordance with various embodiments of the present invention;

FIG. 8 illustrates a schematic representation showing the differences between ephemeral assets or contents and assets or contents useful or long period of time, in accordance with various embodiments of the present invention;

FIG. 9 illustrates a schematic representation of assigning relevance scores, in accordance with various embodiments of the present invention;

FIG. 10 is a schematic representation of associating assets or contents with level of difficulty, in accordance with various embodiments of the present invention; and

FIG. 11-12 is a schematic representation of various features of the computer implemented method, in accordance with various embodiments of the present invention;

Like reference numerals refer to like parts throughout the description of several views of the drawing.

### DETAILED DESCRIPTION OF THE DISCLOSURE

The exemplary embodiments described herein detail for illustrative purposes are subject to many variations. It should be emphasized, however, that the present invention is not limited to a computer implemented method for providing quality content to a user as illustrated herein. It is understood that various omissions and substitutions of equivalents are contemplated as circumstances may suggest or render expedient, but these are intended to cover the application or implementation without departing from the spirit or scope of the present invention.

The terms “a” and “an” herein do not denote a limitation of quantity, but rather denote the presence of at least one of the referenced item.

The terms “having”, “comprising”, “including”, and variations thereof signify the presence of a component.

The present invention provides a computer implemented method for providing quality content or assets to a user. The term content or assets as reference hereinafter could refer one or more of audio, pictures, text, or video content and the like, which may be of interest to the end user. Further, the terms ‘content’ or ‘assets’ will be interchangeably used throughout the description.

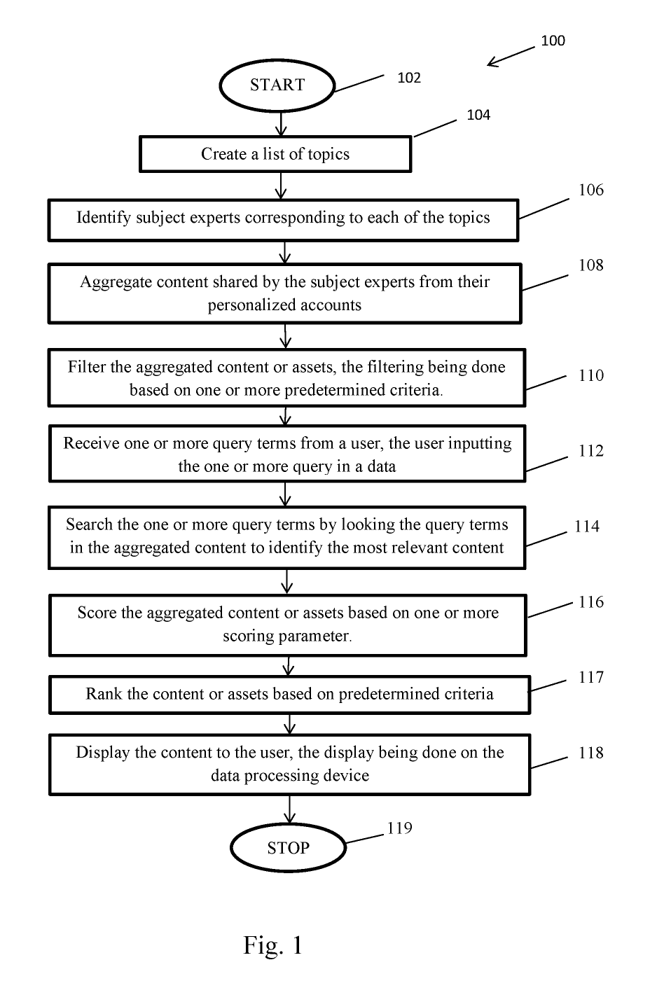

It should be understood that initially the computer implemented method includes creating a list of topics and then identifying subject experts for each of the topics. Further, as subject experts share any contents or assets on their personalized account, the computer implemented method includes retrieving content or assets corresponding to the topics. In this manner a database is organized for topics and further for subject experts. Further the database is organized for contents or assets. Further the method includes receiving one or more query terms from a user. The user inputs the one or more query in a data processing device. Further the method includes searching corresponding to query terms to retrieve relevant asset or content. Further, the method displaying the assets or content to the user, wherein the displaying is done on the data processing device. The method is shown with reference to various figures (FIGS. 1-13) referenced in the patent application, and specifically with reference to FIG. 1.

FIG. 1 shows a flow diagram of a computer implemented method 100 for providing quality content to a user. The method 100 starts at step 102. At step 104, the method 100 includes creating a list of topics, which may be of interest to the end user. In one embodiment, the list of topics is created by compiling a predetermined list of topics based on general interest of the user. Such a predetermined list may be compiled from known in the art internet based sources, such as Wikipedia and the like. In another embodiment, the list of topics is created by observing user interest from ‘various user's social media footprint and the like.

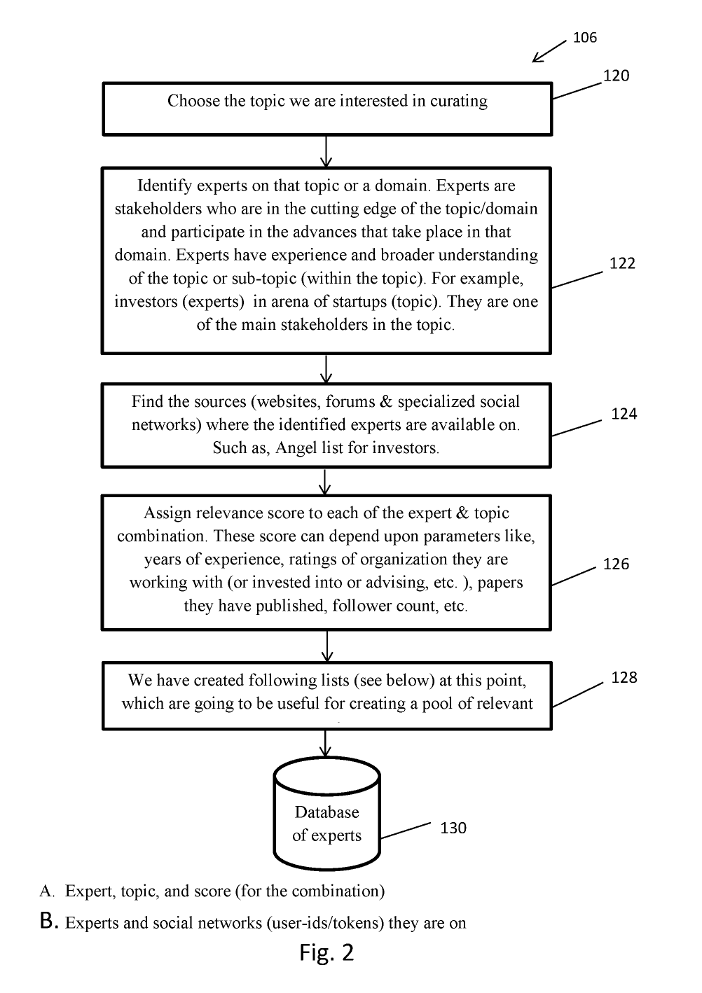

Thereafter, the method 100 flows to step 106. At step 106, the method 100 identifies subject experts corresponding to each topic. In one embodiment, the subject experts are identified based on social media footprint corresponding to a pool of subject experts. In this embodiment, the social media footprint includes one or more of social media followers, number of tweets, re-tweets, number of likes, and number of content shared corresponding to each of the subject experts in the pool. In another embodiment, the subject experts are derived from a list of predetermined experts stored in various freely available expert databases. For example, a list of experts for a topic, such as start ups, could be investors and advisors of investment firms. Further, in one embodiment, to create an initial list of experts, the computer implemented method 100 parses Angel List profiles and LinkedIn profiles, to fetch out the investors and advisors to invest firms. The various ways in which the method 100 identifies subject experts is shown with reference to FIG. 2, and described later in the specification.

Further at step 108, the method 100 aggregates assets or content shared by the subject experts from their personalized accounts. In one embodiment, the content is aggregated from twitter accounts, LinkedIn accounts and the like, of the subject experts. In other embodiment, the content is aggregated from various blogs, and websites, and other like sources, which the subject experts have authored.

Thereafter the method 100 moves to step 110. At step 110, the method 100 filters the aggregated content or assets, the filtering being done based on one or more predetermined criteria. In one embodiment the aggregated content is filtered based on expertise of the subject expert sharing the content. That is the method 100 filters content or assets which are shared by experts which are actually low on expertise corresponding to a topic. In other embodiment the aggregated content is filtered based on identifying personal characteristic of the subject expert sharing the content. The method 100 then flows to step 112, where the method 100 receives one or more query term from the user, the user inputting the one or more query term in the data processing device, such as a mobile phone, a tablet computer, a personal computer and the like.

The method 100 then moves to step 114, where the method 100 searches the one or more query terms by looking the query terms in the aggregated content to identify the most relevant content corresponding to the query terms. Further the method 100 flows to step 116. At step 116, the method 100 scores the aggregated content or assets based on one or more scoring parameter. The method 100 then flows to step 117, where the method 100 rank the content or assets based on predetermined criteria. The ranking of the assets or content is based on a profile of the user and other parameters explained later. Finally at step 118, the method 100 displays the content or asset to the user on the data processing device. In one embodiment, the content is displayed based on a profile of the user. The method 100 then flows to step 119, where it gets terminated.

FIG. 2 shows a block diagram of the method 106 to identify subject experts corresponding to each topic. The method 106 initiates at step 120. At step 120, the user chooses a topic from the list of topic. Thereafter, the method 106 flows to step 122. At step 122, the method 106 identifies subject experts on that topic or domain. It should be understood that subject experts are stakeholders who are in the cutting edge of the topic/domain and participate in the advances that take place in that domain. These experts have experience and broader understanding of the topic or sub-topic (within the topic). For example, for a topic, such as startups, the experts could be investors. It will be apparent that investors are one of the main stakeholders in the topic of start ups.

Further at step 124, the method 106 finds the sources (websites, forums & specialized social networks) where the identified experts are available on. Suitable examples of the websites, forums may include, but are not limited to, Angel list for investors, Hall of fame of investors, and other such lists. The method 106 then moves to step 126. At step 126, the method 106 assigns relevance score to each of the expert & topic combination. These score can depend upon parameters like, years of experience, ratings of organization they are working with (or invested into or advising, and other such topics), papers they have published, follower count, and the like. The method then flows to step 128, where the method 106 creates lists at this point. For example, the method 106 may create a, —List (A) expert, topic, and score (for the combination) and List (B) experts and social networks (user-ids/tokens) they are associated. Finally, the method 106 moves to step 130. At step 130 a database of subject experts is organized and maintained and method 106 terminates thereafter.

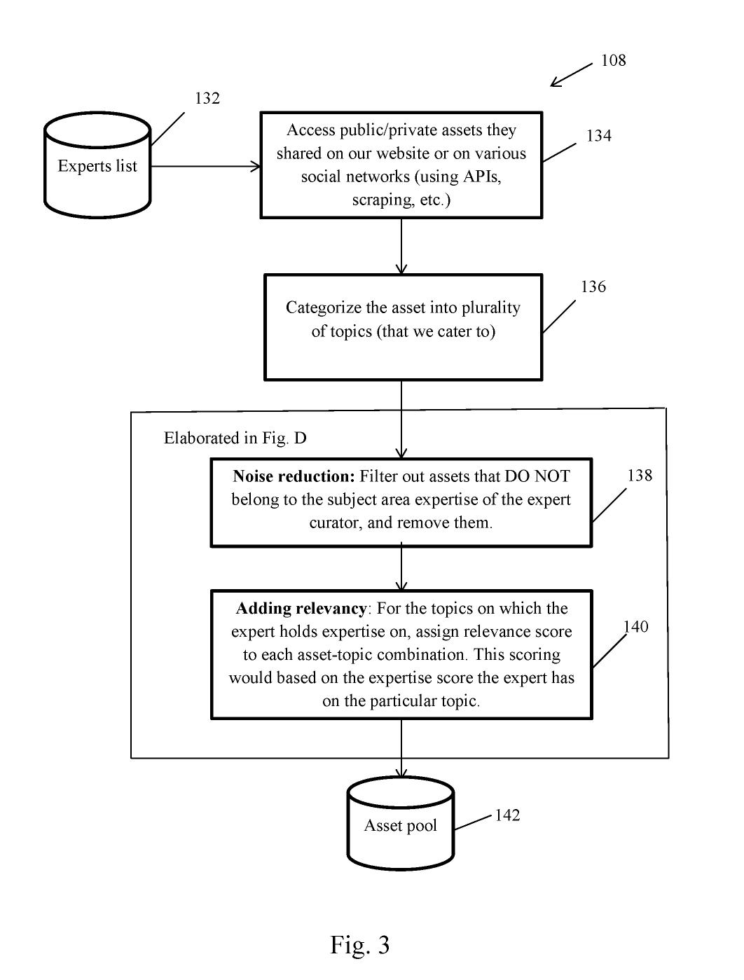

FIG. 3 shows a block diagram of the method 108 to create assets pool or content pool. The method 108 starts at step 132. At step 132 subject experts list is ready to be used. Thereafter method flows to step 134. At step 134, the method 108 accesses public/private assets or content that subject experts shared on websites or on various social networks. In one embodiment, the accessing is done using, APIs, scraping and the like. Further at step 136, the method 108 categorizes the assets or content into plurality of topics. The method 108 then further moves to step 138, where the method 108 reduces noise i.e. filters out assets or content that do not belong to the subject area expertise of the expert, and removes such redundant assets or contents. Further the method 108 flows to step 140. At step 140 for the topics on which the subject expert holds expertise, the method 108 assigns relevance score to each asset-topic combination. This scoring will be based on the expertise score the expert has on the particular topic. Finally, the method 108 flows to its final step 140 where the assets or content pool is organized.

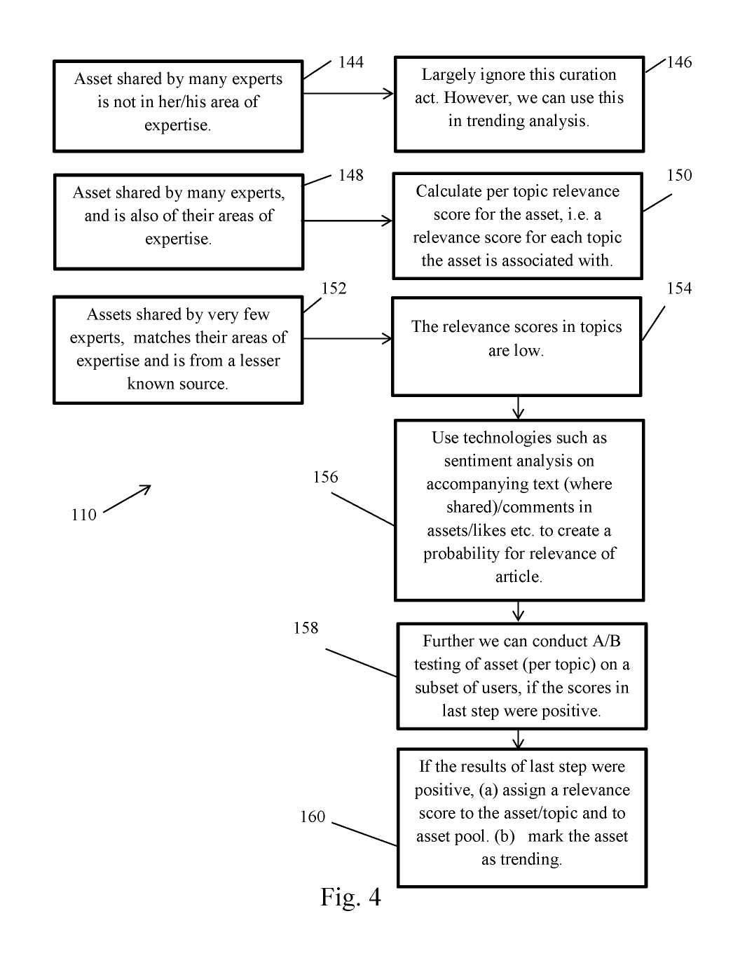

FIG. 4 shows a set of block diagrams of the method 110 to filter the aggregated content or assets. The filtering is being done based on one or more predetermined criteria. The method starts with first set of block diagram at step 144. At step 144, the method 110 searches for assets or content shared by many experts, which is not in her/his area of expertise. The method 110 then flow to step 146 of first set of block diagram. At step 146, the method 146, removes the contents or assets identified in step 144. However, method 110 can use the assets or contents in trending analysis. The first set of block diagram of method 110 terminates thereafter.

Further the second set of block diagram of method 110 starts at step 148. At step 148, the method 110 searches for assets or contents shared by subject experts. Thereafter, method 110 flows to step 150 of second set of block diagram. At step 150 the method 110 calculates per topic relevance score for the asset or content, i.e. a relevance score for each topic the asset or content is associated with.

Furthermore the third and final set of block diagram of method 110 starts at step 152. At step 152, the method searches for assets or content shared by few of subject experts, matches their areas of expertise and also those assets or content that are from a lesser known source. The method 110 then flows to step 154 where method 110 assigns low relevance scores to these assets or content in their respective topics. At step 156 the method 110 use technologies such as sentiment analysis on accompanying text (where shared)/comments in assets/likes and on other such parameter to create a probability for relevance of the assets or contents. Thereafter the method 110 flows to the step 158. At step 158, the method 110 further conducts A/B testing of asset or content (per topic) on a subset of users, if the scores in step 156 were positive. The method 110 further moves to step 160 where method perform two function if the results of last step were positive. At step 160, the functions to be performed are (a) assign a relevance score to the asset/topic and to asset pool, and (b) mark the asset or content as trending. The method terminates thereafter.

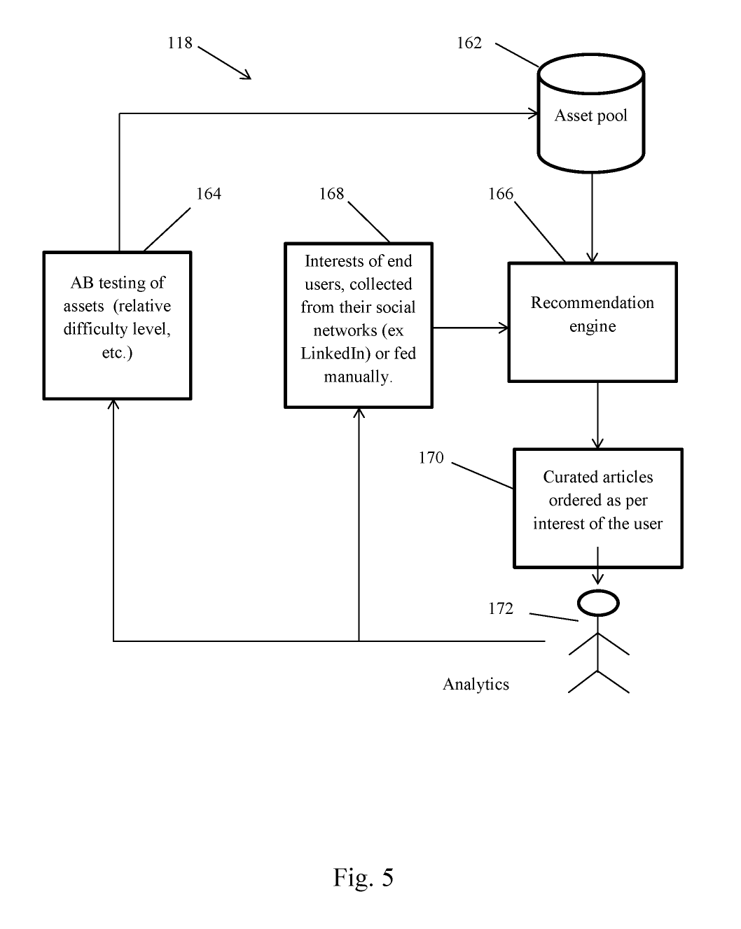

FIG. 5 shows a block diagram of the method 118 to deliver useful assets or content to the end user in a personalised manner. The method starts at step 162 where assets or content pool is organized and is ready to deliver to the end user. The step 162 is accompanied by the step 164 of the method 118. The assets or content pool at step 162 also contain assets or content at step 164. The assets or content at step 164 are those assets or contents which are reviewed by user and passes AB test (relative difficulty level and the like) with positive scores. In a way the step 164 also provides the feedback for previously delivered assets or content to the end user. Thereafter method 118 flows to step 166. At step 166, the method sends useful assets or content from the assets or content pool to the recommendation engine. In recommendation engine, the most relevant content or assets are recommended for the delivery to the end user. The assets or content are recommended by consistently observing the user interest from user's social network account such as LinkedIn, twitter and other social media, and the like. Further the method 118 moves to the step 170, where curated assets or content as per interest of the user is organized. Finally the curated assets or content is delivered to the end user 172 in a personalised manner.

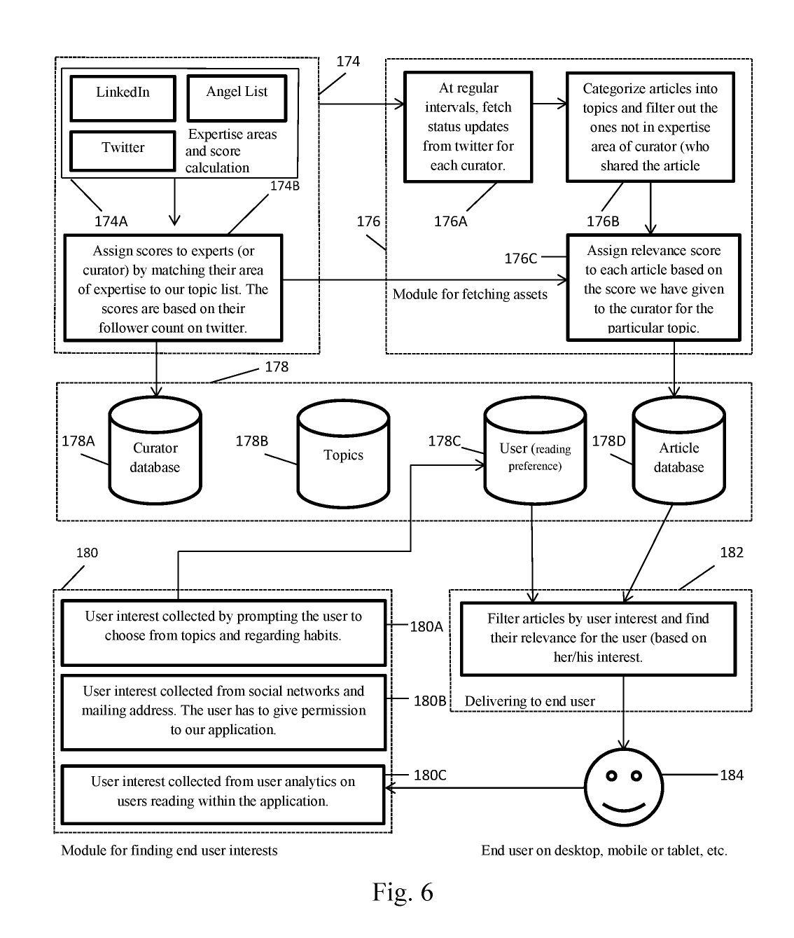

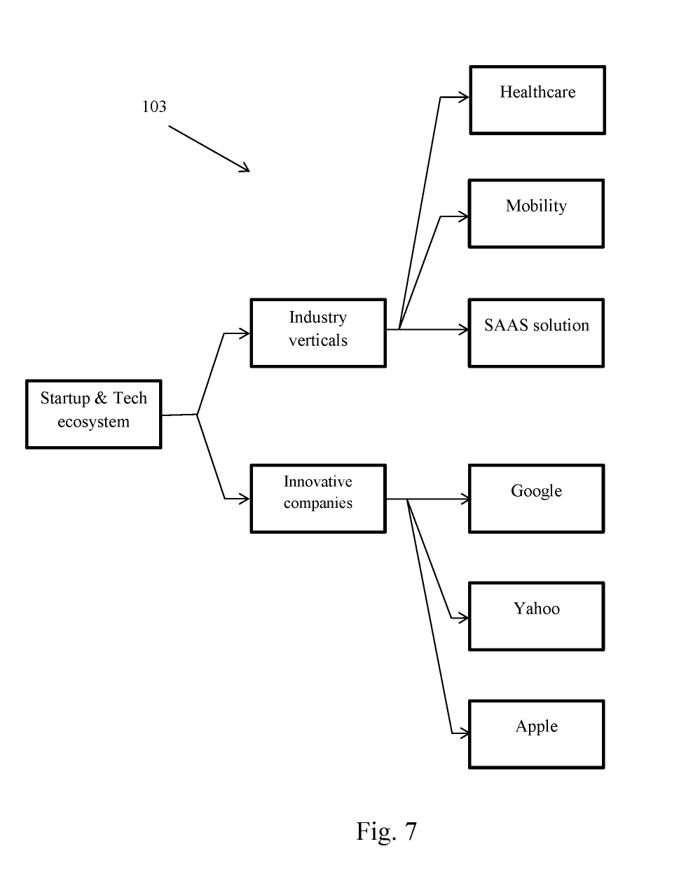

FIG. 6-7 shows schematic representations of a system for providing quality content to a user. The block diagram is further divided into their respective steps. The system is configured, to create expert lists, as shown by block 174. More specifically, the system configured to step 174A, where the system looks into social media accounts for example Angel list, LinkedIn, twitter and the like of several experts to determine their area of expertise. The system then moves to step 174B. At step 174B, the system assigns scores to experts (or curators) by matching their area of expertise to topic list. The scores are based on their follower counts twitter. The system then flows to database design 178, where experts database is organized i.e. 178A.

The system then moves to its next step 176, which deals with module for fetching assets or content. At this step 176, the system starts at step 176A. At step 176A, the system fetches status updates from twitter for each expert at regular interval. At step 176B, the system categorizes assets or content into topics and filter out the ones not in expertise area of expert (who shared the assets or content). Thereafter, the system flows to step 176C, where the system assigns relevance score to each assets or content based on the score we have given to the expert for the particular topic. The step 176C takes place also with the contribution of step 174B. The system then flows to database design 178, where assets or content database is organized i.e. at 178D.

The system includes a segment that is database design 178. At database design 178, the system organises and arranges several databases like expert database 178A, topics 178B, users (reading preferences) database 178C and assets or content database 178D.

The users (reading preference) database 178C is organised in the segment database design 178 of the system on the basis of three pre-determined criteria. At step 180, the module for finding end user interest is shown in which those pre-determined criteria's are stated. Those criteria are (A) user interest collected by prompting the user to choose from topics and regarding habits, (B) user interest collected from social networks or other sources of personal or professional data (this step would need users approval), (C) user interest collected from user analytics on users reading within the method.

The system, then flows to step 182 where the system receives assets or content from users (reading preferences) database 178C and assets or content database 178D and further filters assets or content by user interest and find their relevance for the user (based on her/his interest). The system then moves to step 184. At step 184, the system delivers assets or content to the end user, the end user being on desktop, mobile, tablet and the like.

FIG. 7 shows block diagram of topic structure as presented to the user.

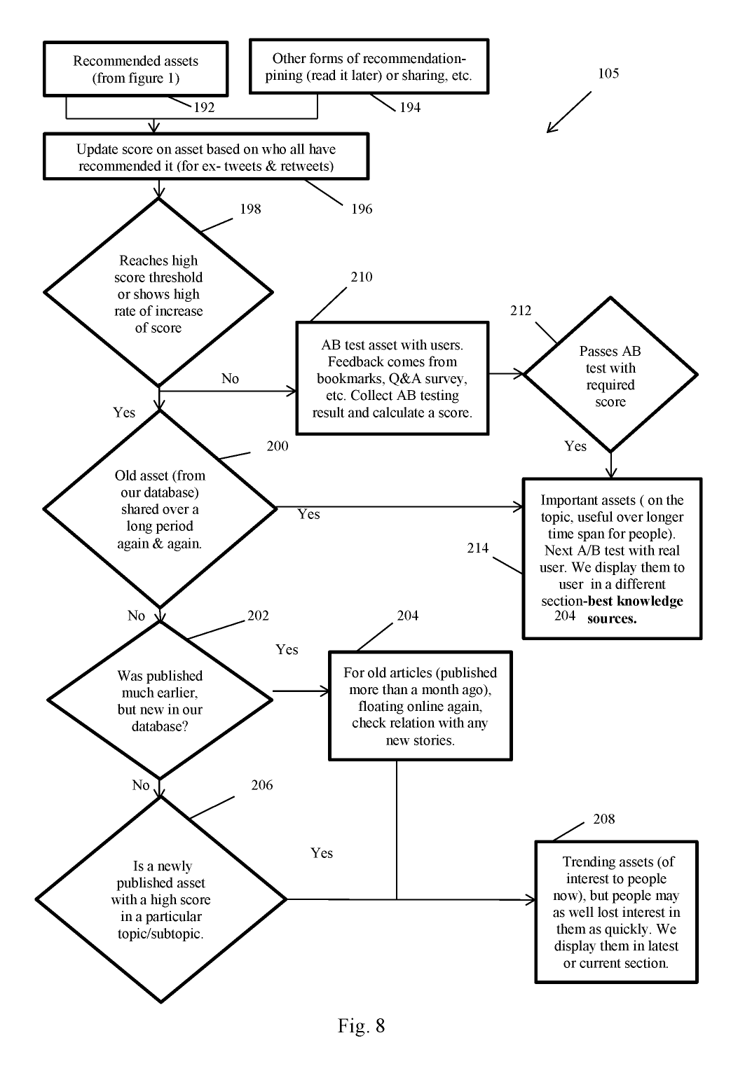

FIG. 8 shows a block diagram of a method 105, for differing between ephemeral assets and assets useful over longer period of time. The method 115 initiates from (a) from step 192, where recommended assets or content are taken as stated in FIG. 1 and (b) from step 194, where assets or content are taken from other form of recommendation, for example pinning, resharing and the like. The method then flows to step 196 where method 105, update score on asset or content based on who all have recommended it, for ex-tweets & retweets and the like. At step 198, the method 105 checks whether asset or content reaches high score threshold (shows high rate of increase of score) or not.

If the result is NO then the method flows to step 210, where method 105 conduct AB test on asset or content with users. Feedback comes from bookmarks, Q&A survey, and the like, further the method 105 collect AB testing result and calculate a score. At step 212, the method 105 decides whether the asset or content passed AB test or not. If the result is YES then the method 105 moves to step 214 where that asset or content is located in the category of important assets or content (on the topic, useful over longer time span for people). Further the method 105 conduct A/B test with real users. The method 105 displays those asset or content in a different section-best knowledge sources.

If the result after step 198 comes YES then the method 105 moves to step 200. At step 200, the method 105 checks whether the asset or content is an old asset or content (from our database) shared over a long period again & again or not. If the result is YES then the method 105 moves to step 214 where that asset or content is located in the category of important assets or content (on the topic, useful over longer time span for people). Further the method 105 conduct A/B test with real users. The method 105 displays those asset or content in a different section-best knowledge sources.

If the result at step 200 is NO then that asset or content is send to step 202. At step 202, the method 105 checks if the asset or content was published much earlier, but new in system database. If the result is YES then the method 105 moves to step 204 where old assets or content (published more than a month ago) are arranged. The method 105 checks relation of those assets and content with the new stories and then decides whether which assets or content are needed to be display in latest or current section.

If the result is NO then method 105 moves to step 206. At step 206, the method 105 decides whether the asset or content published is a newly published asset or content with a high score in a particular topic/subtopic or not. If the result is YES then the method 105 moves to step 208. At step 208 the method 105 aggregates assets or content from step 204 and step 206 and display those assets or content in latest or current section. The method 105 terminates thereafter.

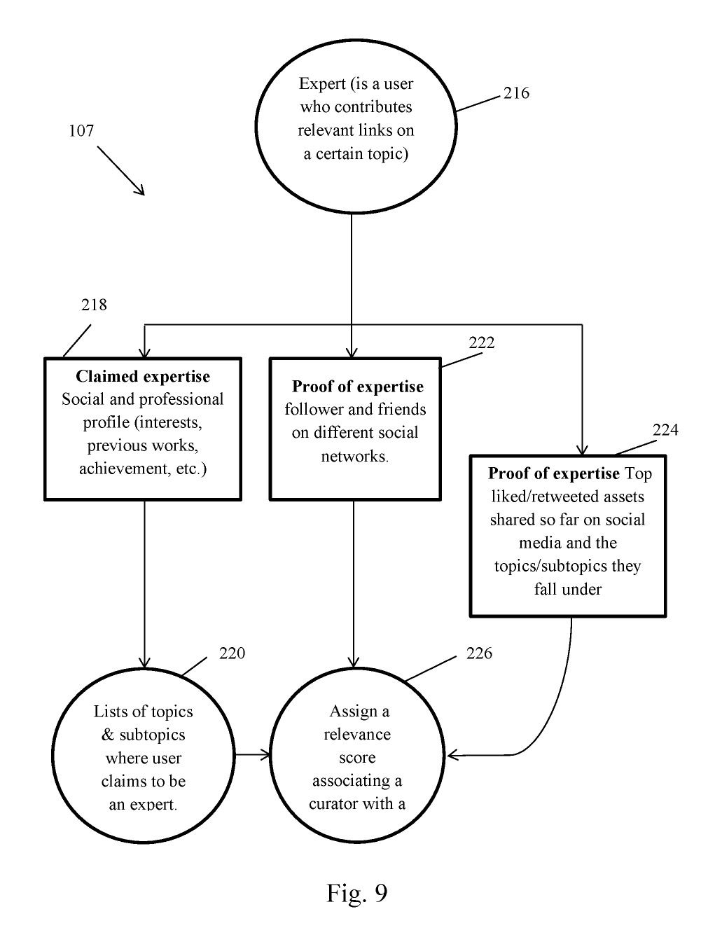

FIG. 9 shows a block diagram of a method 107, to assign a relevance score to each topic & expert combination. The method 107 starts at step 216. At step 216, a subject expert contributes relevant contents or assets on a certain topic. Further at step 218 of method 105 the subject expert claims his/her expertise based on Social and professional profile (interests, previous works, achievement and the like). Further at step 220, lists of topics & subtopics are organized where user claims to be an subject expert. At step 222, the method 107 examines proof of expertise based on follower and friends on different social networks. The method 107 again at step 224 examines proof of expertise based on top liked/retweeted assets or content shared so far on social media and the topics/subtopics they fall under. After examination based on several parameters from step 218, 222 and 224, finally the method 107 at step 226 assign a relevance score associating a subject expert with a topic. The method 107 terminates thereafter.

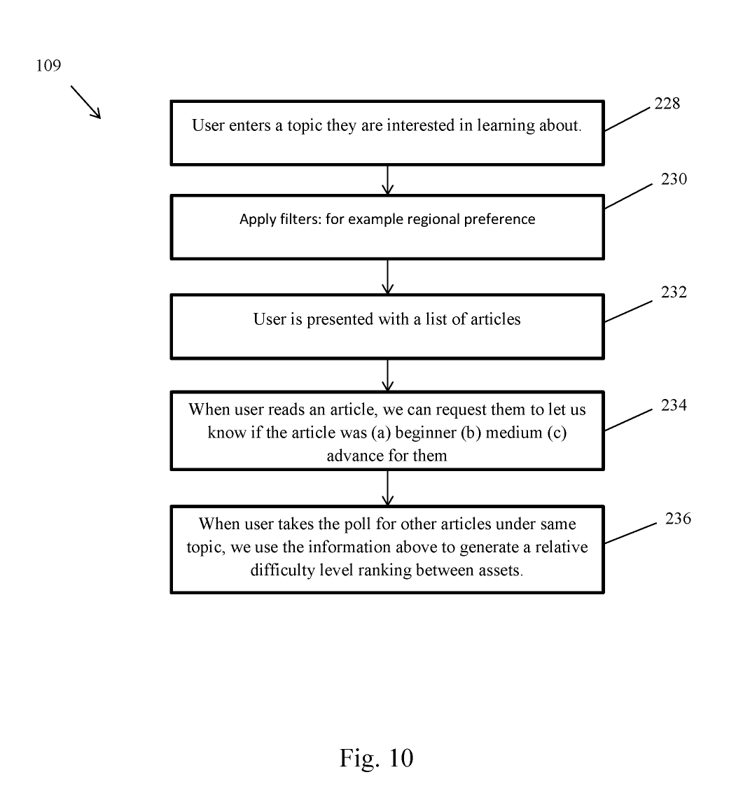

FIG. 10 shows a flow diagram of a method 109, to arrange assets or contents in accordance with the level of difficulty. The method 109 initiates at step 228, where user enters a topic they are interested in learning about. Thereafter the method 109 flows to step 230. At step 230, the method 109 applies filters, for example regional preferences and other similar filters. Further at step 232, the user is presented with a list of contents or assets. The method 109 then flows to step 234, where when user explores the contents (for example reads the assets or content shared), the method can request them to respond back if the assets or content was (a) beginner (b) medium (c) advance for them. The response of the user (about the quality or nature of the content or asset) is considered with relation to (1) his or her expertise score over the topic (if available) and also (2) with relation to the ratings given, by the same user, to other content or asset under the same topic. Finally at step 236, when user takes similar poll for other assets or content under same topic, (for example, presented to the user as a results of a search), consumed by the user around same time frame, the information is retrieved at step 234 to generate a relative difficulty level ranking (or other metadata relevant for ranking) between assets or contents. This step is relevant because ranking quality of an asset is a very subjective matter and comparison between rankings given by different users is not straight forward. For example, while a novice might find an asset too hard, an expert would find it too beginner and easy. Also time frame is important because the expertise of a user (over the topic) would increase over time and would change their perceptions of easy and difficult. Therefore we consider either (1) the expertise scores of recommenders or (2) we consider the assets or contents performance in relation to its peers, while affecting the rankings between the assets or content under a topic. The method 109 terminates thereafter.

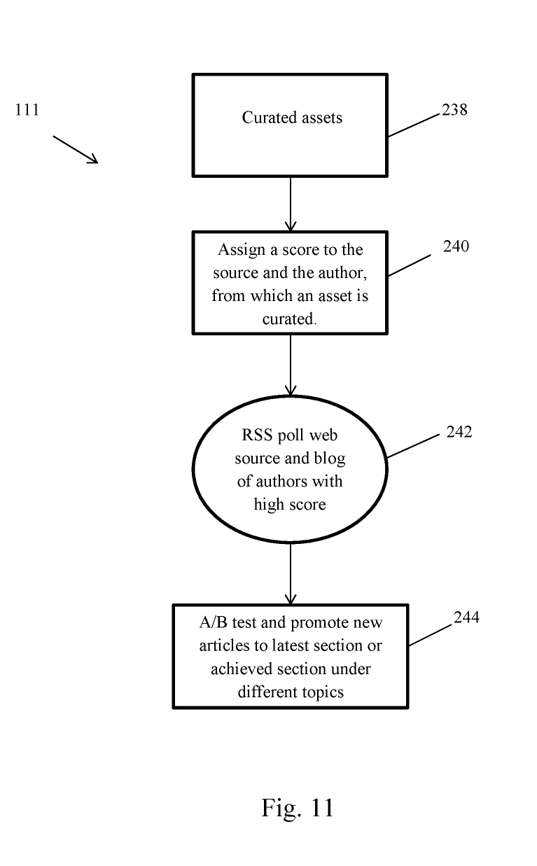

FIG. 11 shows a flow diagram of a method 111, to aggregate assets from known sources and of known authors. The method 111 initiates at step 238 where assets or contents are organized. Further at step 240, the method 111 assigns a score to the source and the author, from which an asset is retrieved. The method then flows to step 242 of the method 111 where RSS feeds, web source and blogs of authors with high scores are used to monitor activity of such sources and author which are producing useful assets or content. Whenever a new asset or content is published by them, the method 111 collects them. At final step 244, the method 111 runs A/B test on collected assets or content and further identify useful assets or content. The method 111 terminates thereafter.

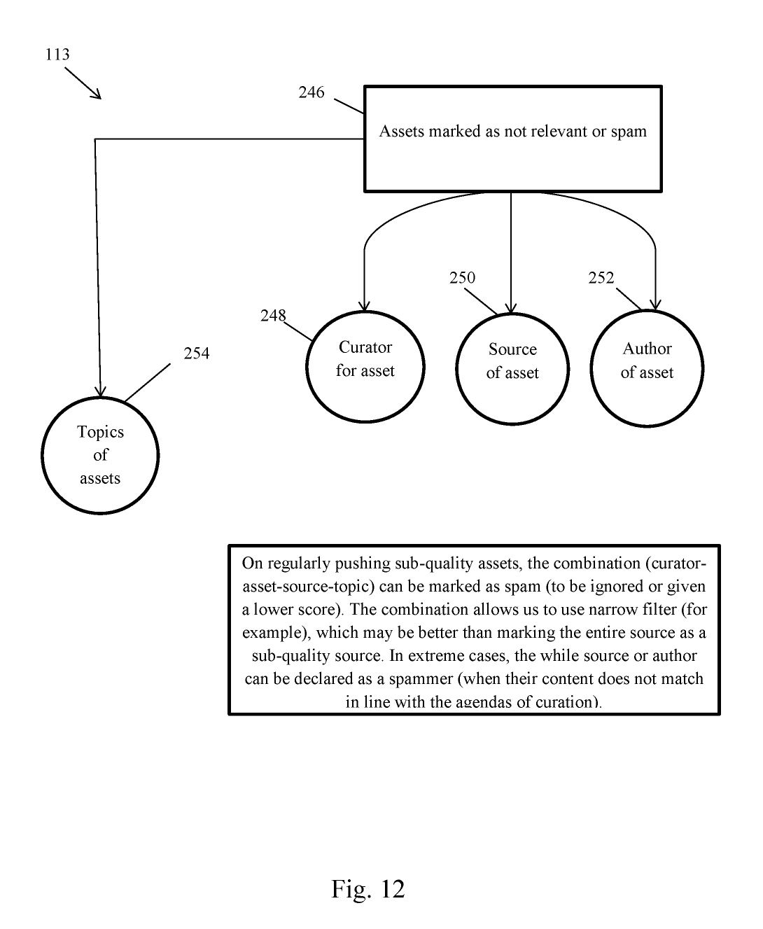

FIG. 12 shows a block diagram of a method 113, to handle spam. The method 113 starts at step 246, where assets or contents are marked as not relevant or spam. The method 113 then flows to step 248, where experts who recommended these (spam) assets or content, are given negative ratings. If a pattern is found in which the experts share irrelevant content from a particular or few sources (because sometimes they have an affiliation with a particular source, such as their own blogs), their recommendations for the particular source are not considered as recommendations. Their recommendations from other sources would still be considered as an expert recommended content. At step 250, the sources of those assets or content are also marked as spam or irrelevant. Further at step 252, the authors of those assets or content are also marked as spam or irrelevant. Accordingly at step 254 of the method 113, the topics of those assets or content are also marked as spam or irrelevant and finally the method 113 gets terminated.

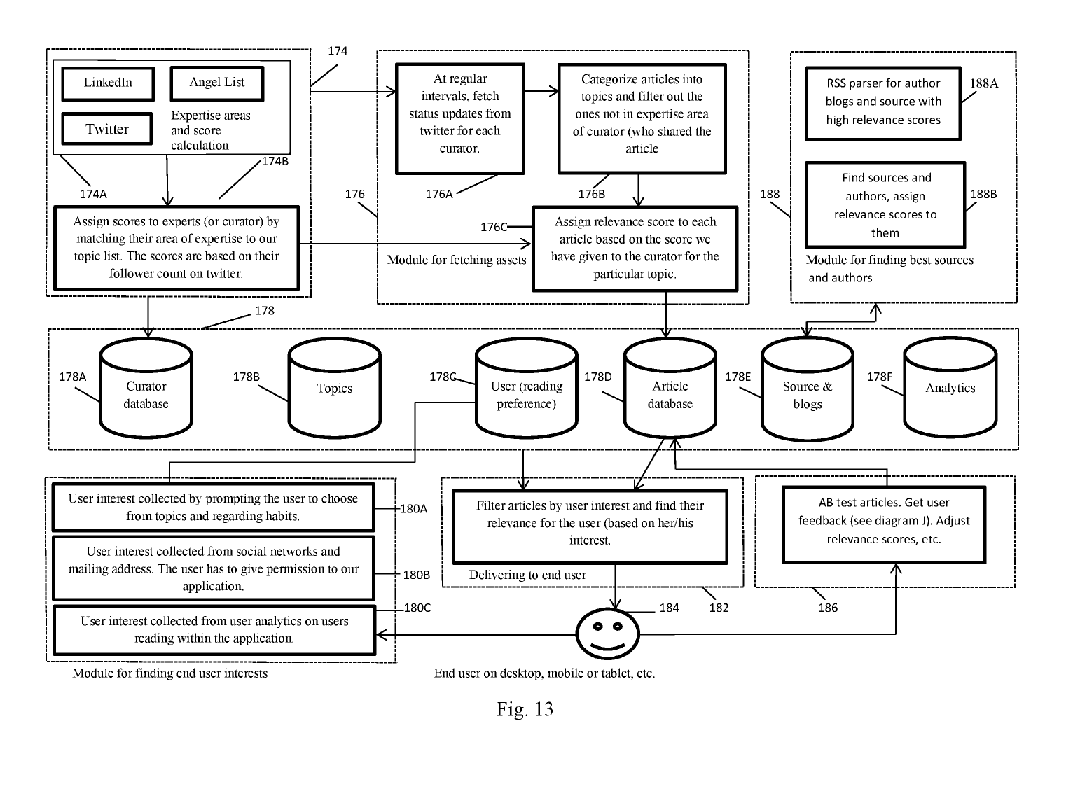

FIG. 13 shows a schematic representation of a system for for system structure in detail. The block diagram is further divided into their respective steps. The system is configured, to create expert lists, as shown by block 174. More specifically, the system configured to step 174A, where the system looks into social media accounts for example Angel list, LinkedIn, twitter and the like of several experts to determine their area of expertise. The system then moves to step 174B. At step 174B, the system assigns scores to experts (or curators) by matching their area of expertise to topic list. The scores are based on their follower counts twitter. The system then flows to database design 178, where experts database is organized i.e. 178A.

The system then moves to its next step 176, which deals with module for fetching assets or content. At this step 176, the system starts at step 176A. At step 176A, the system fetches status updates from twitter for each expert at regular interval. At step 176B, the system categorizes assets or content into topics and filter out the ones not in expertise area of expert (who shared the assets or content). Thereafter, the system flows to step 176C, where the system assigns relevance score to each assets or content based on the score we have given to the expert for the particular topic. The step 176C takes place also with the contribution of step 174B. The system then flows to database design 178, where assets or content database is organized i.e. at 178D.

The system includes a set of block diagram 188, module for finding best sources and authors. This module keeps itself connected with module for fetching assets or content 176 to facilitate fetching of relevant assets or content only. This module 188 performs two functions at step 188A and at step 188B. At step 188A the module 188 monitor activity of such sources and authors which are producing useful assets or content. RSS feeds, web source and blogs of authors with high scores are used to monitor activity of such sources and authors. Further at step 188B the module 188 collect the assets or content published by the useful sources and authors and finally assign relevance score to them. The module for finding best sources and authors 188 keeps itself connected with source and blogs database 178E which is described further in the description.

The system includes a segment that is database design 178. At database design 178, the system organises and arranges several databases. The segment database design 178 contains databases like expert database 178A, topics 178B, users (reading preferences) database 178C, assets or content database 178D, source and blogs database 178E and analytics database 178F.

The users (reading preference) database 178C is organised in the segment database design 178 of system on the basis of three pre-determined criteria. At step 180, the module for finding end user interest is shown in which those pre-determined criteria's are stated. Those criteria are (A) user interest collected by prompting the user to choose from topics and regarding habits, (B) user interest collected from social networks and mailing address. The user has to give permission to method, (C) user interest collected from user analytics on users reading within the method.

The system, then flows to step 182 where system receives assets or content from users (reading preferences) database 178C and assets or content database 178D and further filter assets or content by user interest and find their relevance for the user (based on her/his interest). The system then moves to step 184. At step 184, the system delivers assets or content to the end user, the end user being on desktop, mobile, tablet and the like. Further the system flows to step 186, where system perform A/B test on assets or content, receive user feedback (see FIG. 10) and adjust relevance scores and the like. The system then further select the useful assets or content from the step 186 and send those assets or content to assets or content database 178D. In this manner system again repeats the intermediate steps and thus provides quality content or assets to the end user.

The advantages of the computer implemented method 100 are many fold. Firstly the computer implemented method 100 is capable of delivering limited as well as relevant contents or assets in minimum possible time to a user. Secondly the computer implemented method 100 is such a method where user would be able to search for contents or assets, depending on his/her need. Furthermore the computer implemented method 100 ensures that the contents or assets are coming from reliable sources and accordingly these contents or assets will be to be rated or scored based on their creator.

Moreover the computer implemented method 100 develops discussion forums or like, where users will be able to clear doubts on the contents or assets, if required. In these discussion forums, the association between the participating users and their expertise scores on topics, would be used to rate the discussions. And vice versa, participating in discussions will lead to increase in expertise scores. A high rated discussion, about an asset or content, results in increased ratings for the assets. Furthermore the computer implemented method 100 incorporates a feedback mechanism from the users in order to facilitate user participation in process of selecting the best assets or content.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present invention.

The system, as described in the disclosed teachings or any of its components, may be embodied in the form of a computer system. Typical examples of a computer system include a general-purpose computer, a PDA, a cell phone, a programmed microprocessor, a micro-controller, a peripheral integrated circuit element, and other devices or arrangements of devices that are capable of implementing the steps that constitute the method of the disclosed teachings.

In a computer system comprising a general-purpose computer, such may include an input device, and a display unit. Specifically, the computer may comprise a microprocessor, where the microprocessor is connected to a communication bus. The computer may also include a memory—the memory may include Random Access Memory (RAM) and Read Only Memory (ROM). The computer system further comprises a storage device—it can be a hard disk drive or a removable storage drive such as a floppy disk drive, optical disk drive, and the like. The storage device can also comprise other, similar means for loading computer programs or other instructions into the computer system.

The computer system may comprise a communication device to communicate with a remote computer through a network. The communication device can be a wireless communication port, a data cable connecting the computer system with the network, and the like. The network can be a Local Area Network (LAN) or a Wide Area Network (WAN) such as the Internet and the like. The remote computer that is connected to the network can be a general-purpose computer, a server, a PDA, and the like. Further, the computer system can access information from the remote computer through the network.

The computer system executes a set of instructions that are stored in one or more storage elements in order to process input data. The storage elements may also hold data or other information as desired. The storage element may be in the form of an information source or a physical memory element present in the processing machine.

The set of instructions may include various commands that instruct the processing machine to perform specific tasks such as the steps that constitute the method of the disclosed teachings. The set of instructions may be in the form of a software program. The software may be in various forms such as system software or application software. Further, the software might be in the form of a collection of separate programs, a program module with a larger program or a portion of a program module. The software might also include modular programming in the form of object-oriented programming. The software program or programs may be provided as a computer program product, such as in the form of a computer readable medium with the program or programs containing the set of instructions embodied therein. The processing of input data by the processing machine may be in response to user commands or in response to the results of previous processing or in response to a request made by another processing machine.

What is claimed is:

1. A computer implemented method for providing quality content to a user, the content being one or more of audio, pictures, text, or video content, and the like, the computer implemented method comprising:
creating a list of topics;
identifying subject experts corresponding to each of the topics;
aggregating content shared by the subject experts from their personalized accounts;
receiving one or more query terms from a user, the user inputting the one or more query in a data processing device;
searching the one or more query terms by looking the one or query terms in the aggregated content to identify the most relevant content corresponding to the one or more query terms; and

2. displaying the content to the user, the display being done on the data processing device.

3. The computer implemented method as claimed in claim 1, wherein the personalized accounts comprises one or more of social network accounts, twitter accounts, Facebook accounts, discussion forums and personalized blogs.

4. The computer implemented method as claimed in claim 1, wherein the personalized accounts are dedicated third party website accounts.

5. The computer implemented method as claimed in claim 1, wherein identifying the subject experts is based on social media footprint corresponding to a pool of subject experts.

6. The computer implemented method as claimed in claim 4, wherein the social media footprint comprises one or more of social media followers, number of tweets, re-tweets, number of likes, and number of content shared corresponding to each of the subject experts in the pool.

7. The computer implemented method as claimed in claim 1, wherein identifying the subject experts is derived from a list of predetermined experts stored in an expert database.

8. The computer implemented method as claimed in claim 1, further comprising filtering the aggregating content, the filtering being done based on one or more predetermined criteria.

9. The computer implemented method as claimed in claim 8, wherein the aggregated content is filtered based on expertise of the subject expert sharing the content.

10. The computer implemented method as claimed in claim 8, wherein the aggregated content is filtered based on identifying personal characteristic of the subject expert sharing the content.

11. The computer implemented method as claimed in claim 1, wherein the content is aggregated from twitter accounts of the subject experts.

12. The computer implemented method as claimed in claim 1, further comprising scoring the aggregating content based on one or more scoring parameters.

13. The computer implemented method as claimed in claim 1, further comprising storing the content in a database.

14. The computer implemented method as claimed in claim 1, further comprising ranking the content based on predetermined criteria.

15. The computer implemented method as claimed in claim 14, wherein ranking of the content is based on a profile of the user.
